(19) United States
(12) Patent Application Publication
(10) Pub. No.: US 2013/0250356 A1
(43) Pub. Date: Sep. 26, 2013

(54) PRINT DATA DISTRIBUTION MANAGEMENT SYSTEM, PRINT DATA DISTRIBUTION MANAGEMENT METHOD AND PRINTING DEVICE

(71) Applicants: CASIO ELECTRONICS MANUFACTURING CO.,, Iruma-shi (JP); CASIO COMPUTER CO., LTD., Tokyo (JP)

(72) Inventor: Miyoshi SASAKURA, Tokyo (JP)

(73) Assignees: CASIO COMPUTER CO., LTD., Tokyo (JP); CASIO ELECTRONICS MANUFACTURING CO., LTD., Iruma-shi (JP)

(21) Appl. No.: 13/846,035

(22) Filed: Mar. 18, 2013

(30) Foreign Application Priority Data
Mar. 21, 2012 (JP) 2012-064607

(51) Int. Cl. G06F 3/12

(52) U.S. Cl. CPC G06F 3/1238
USPC 358/1.15

(57) ABSTRACT

The print data distribution management system comprising a distributor terminal used by a user who is the distributor of print data to be distributed, a recipient terminals used by a distribution receiver of the print data to be distributed and a printing device connected to the distributor terminal and the recipient terminal via a network and printing the print data distributed. The distributor terminal comprises a transmitter including information specifying the distribution receiver in the print data and sending the print data to the printing device. The printing device comprises a print controller analyzing the print data sent from the transmitter of the distributor terminal and creating print image data, a print outputter printing out the print image data on a recording medium based on print instruction from the distribution receiver and a distribution status manager managing the distribution status of the print image data with the distribution receiver.

### CROSS-REFERENCE TO RELATED APPLICATION

This application claims the benefit of Japanese Patent Application No. 2012-064607, filed on Mar. 21, 2012, the entire disclosure of which is incorporated by reference herein.

### FIELD

This application relates generally to a system in which a host machine such as a personal computer (PC) and a printer are connected via a network, and more particularly, to a print data distribution management system for distributing print data to multiple users from a host machine.

### BACKGROUND

Nowadays, computer networks are in extensive used and systems in which a printing device is connected to a network such as a LAN (local area network) and print data are transmitted from a host machine such as a personal computer (PC) for printing are used. In such systems, the host machine and printing device are often installed at separate places away from each other. For printing a confidential document, there is concern that someone may read the printout.

In the recent information society, an increasing amount of information is handled and printing devices such as printers, MFP (multifunction printers), and copy machines are accordingly in more use, which augments the above concern. There is growing social awareness of security and additional care is required in handling information.

For that reason, for ensuring confidentiality, fingerprint authentication or ID card authentication is executed on a printing device such as a printer and MFP before making the printout.

Unexamined Japanese Patent Application Kokai Publication No. 2008-80652 discloses confidential printing for other parties and discloses a technique of informing the destination of the arrival of confidential print via an email. Also disclosed is a technique with which the printing device sends an email notifying that confidential printing is completed to the recipient after the confidential printout is actually made, and the recipient holds deletion of the output print data until an opening response is normally received.

However, if the function of confidential printing for other parties is used to distribute print data to multiple destinations (recipients), it is impossible to know whether the recipient user has actually executed the confidential printing and received the distributed print data. The opening confirmation reply function of the above Patent Literature 1 is a function for communication between a recipient and a printing device and the distributor is not informed. Furthermore, the opening confirmation reply function is an email function simply informing that the email was viewed. It is very difficult for the distribution destination or recipient to comprehend that the opening confirmation reply function is used to indicate whether the confidential printing is normally executed. Also disclosed is the confidential printing completion notification email function, with which the distributor receives confidential printing completion notification emails from each one of the recipients (printing devices), and the distributor himself/herself has to figure out which user has completed the printing individually, which is very troublesome and cumbersome.

Furthermore, if a missing recipient or a wrong recipient is found for some print data, the handling process becomes complex and cumbersome operation is required. For example, if a missing recipient is found, it is necessary to create new confidential print data from the original distributed document file, register a new recipient, and send a notification email. For that reason, the original document has to be saved.

On the other hand, if print data are distributed to a wrong recipient, it is necessary to send an email to tell the recipient the incident and, if the recipient has already made the confidential printout, ask for disposal of the printout or visit them to retrieve the printout.

### SUMMARY

The print data distribution management system according to a first exemplary aspect of the present invention comprising: a distributor terminal used by a user who is the distributor of print data to be distributed; a recipient terminal used by a distribution receiver of the print data to be distributed; and a printing device connected to the distributor terminal and recipient terminal via a network and printing the print data distributed, wherein the distributor terminal comprises a transmitter including information specifying the distribution receiver in the print data and sending the print data to the printing device, and the printing device comprises: a print controller analyzing the print data sent from the transmitter of the distributor terminal and creating print image data; a print outputter printing out the print image data on a recording medium based on print instruction from the distribution receiver; and a distribution status manager managing the distribution status of the print image data for the distribution receiver.

The print data distribution management method for a print data distribution management system according to a second exemplary aspect of the present invention wherein: the print data distribution management system comprises a distributor terminal used by a user who is the distributor of print data to be distributed; a recipient terminal used by a distribution receiver of the print data to be distributed; and a printing device connected to the distributor terminal and recipient terminal via a network and printing the print data distributed, the distributor terminal executes a transmission procedure to include information specifying the distribution receiver in the print data and send the print data to the printing device, and the printing device executes: a print control procedure to analyze the print data sent from the transmitter of the distributor terminal and create print image data; a printing procedure to print out the print image data on a recording medium based on print instruction from the distribution receiver; and a distribution status management procedure to manage the distribution status of the print image data for the distribution receiver.

The printing device according to a third exemplary aspect of the present invention, the printing device being connected to a distributor terminal which is used by a user who is the distributor of print data to be distributed and a recipient terminal which is used by a distribution receiver of the print data to be distributed via a network and printing the print data distributed, comprising: a print controller analyzing the print data sent from a transmitter of the distributor terminal and creating print image data, the transmitter of the distributor terminal including information specifying the distribution receiver in the print data and sending the print data to the printing device; a print outputter printing out the print image data on a recording medium based on print instruction from the distribution receiver; and a distribution status manager managing the distribution status of the print image data for the distribution receiver.

### BRIEF DESCRIPTION OF THE DRAWINGS

A more complete understanding of this application can be obtained when the following detailed description is considered in conjunction with the following drawings, in which;

FIG. 1 is an illustration showing a specific connection configuration of a printing device and client computers;

FIG. 2 is a system configuration diagram of the print data distribution management system of this embodiment;

FIG. 3 is a flowchart for explaining the user information registration procedure;

FIG. 4 is a flowchart for explaining the procedures of this embodiment;

FIG. 5 is an illustration showing a recipient selection screen;

FIG. 6 is an illustration for explaining the format structure of the distribution request information;

FIG. 7 is an illustration for explaining the data structure of the distribution management file;

FIG. 8 is an illustration for explaining the data structure of the authentication print management table;

FIG. 9 is an illustration showing an exemplary display of the distribution status display;

FIG. 10 is a flowchart for explaining the recipient change procedure when a missing recipient or a wrong recipient is found;

FIG. 11 is an illustration for explaining the change procedure for deleting and/or adding recipients; and

FIG. 12 is a flowchart for explaining the distribution management file deletion procedure.

### DETAILED DESCRIPTION

In the following explanation, a case in which the users participate in a marathon event as an exemplary sport will be described.

An embodiment of the present invention will be described hereafter based on the drawings.

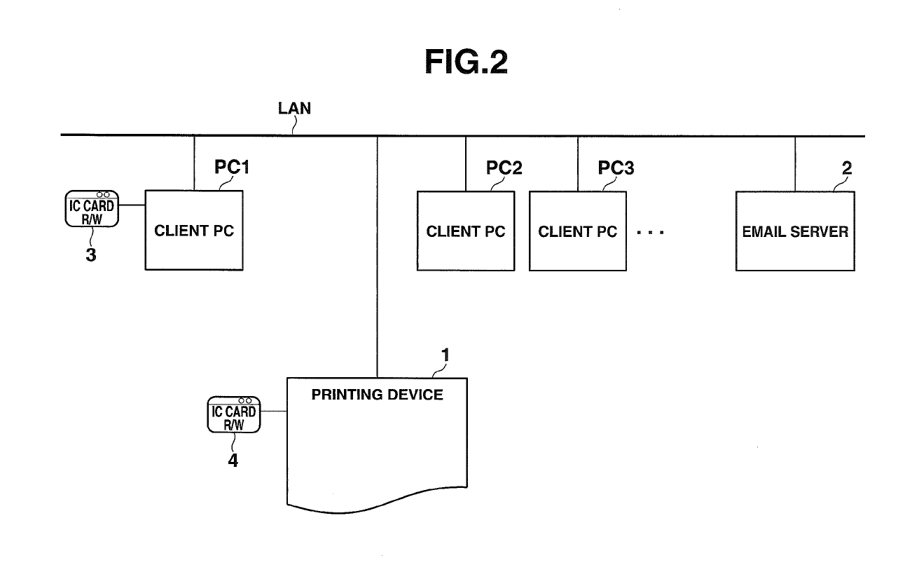

FIG. 2 is a system configuration diagram of the print data distribution management system of this embodiment. In the figure, the system comprises a printing device 1 such as a printer, client computers PC1 to PC3 giving print instruction to the printing device 1, and an email server 2. The printing device 1, client computers PC1 to PC3, and email server 2 are connected by a network via a LAN (local area network).

An IC card reader/writer 3 is connected to the client computer PC 1. As an IC card described later is placed over the IC card reader/writer 3, data are read/written from/into the IC card. Furthermore, an IC card reader/writer 4 is connected to the printing device 1. As an IC card described later is placed over the IC card reader/writer 4, data are read/written from/into the IC card.

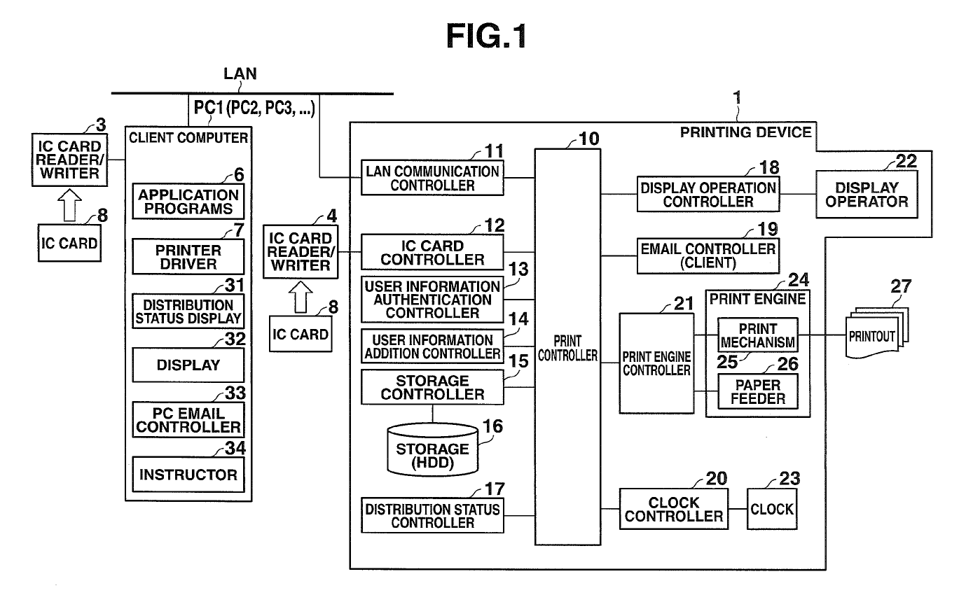

FIG. 1 is an illustration showing a specific connection configuration of the printing device 1 and client computers PC1 to PC3. Here, three client computers PC1 to PC3 are represented by one computer in the figure.

Application programs 6 and a printer driver 7 are installed in the client computer PC1 (PC2, PC3), enabling data exchange with an IC card 8 via the IC card reader/writer 3. The client computer PC1 (PC2, PC3) creates print data using the application programs 6, converts the print data to intermediate data (PDL data) corresponding to the printing device 1 using the printer driver 7, and has a transmitter sending the data to the printing device 1. Here, besides the above components, the client computer PC1 (PC2, PC3) comprises, for example, a keyboard, a mouse, and a display.

The printing device 1 comprises a print controller 10, a LAN communication controller 11, an IC card controller 12, a user information authentication controller 13, a user information addition controller 14, a storage controller 15, a storage (hard disc (HDD)) 16, a distribution status controller 17, a display operation controller 18, an email controller 19, a clock controller 20, and a print engine controller 21. A display operator 22 such as an operation panel is connected to the display operation controller 18. A clock 23 is connected to the clock controller 20. A print engine 24 is connected to the print engine controller 21. The print engine 24 comprises a print mechanism 25 and a paper feeder 26.

The LAN communication controller 11 is an interface for connecting the printing device 1 to a LAN. The printing device 1 is connected to the client computer PC1 (PC2, PC3) via the LAN.

The IC card controller 12 is connected to the IC card reader/writer 4 and exchanges data with the IC card 8 via the IC card reader/writer 4. User authentication information such as a user name and user code and user information such as a user email address and IC card number are recorded on the IC card 8. The information read through the IC card reader/writer 4 is also sent to the print controller 10 via the IC card controller 12.

The user information authentication controller 13 authenticates the user based on the user information such as an IC card number read via the IC card controller 12. The user information addition controller 14 encodes the user information authenticated by the user information authentication controller 13 and adds it to print image data created by the print controller 10 through command analysis on print data.

The storage controller 15 controls writing of data in the storage 16 and reading of data stored in the storage 16. The storage 16 stores the image data and the storage controller 15 reads the image data into the print controller 10. Here, the storage 16 can be provided, for example, on a hard disc (HDD) of an intermediate document server connected to the LAN.

The distribution status controller 17 updates a distribution management file according to the printing status of print data recipients described later. For example, the distribution status controller 17 executes an update procedure for changing a print status flag described later in the distribution management file to PRINTING or PRINTED.

The distribution management file is stored in the storage 16 and accessed via the storage controller 15.

The display operator 22 is, for example, an operation panel comprising a touch panel-type LCD (liquid crystal display) and operation keys. The display operation controller 18 controls the display operation of the display operator 22, transmission of key operation signals from the display operator 22 to the print controller 10, and transmission of display data from the print controller 10 to the display operator 22.

The email controller 19 controls transmission/reception of emails described later, and sends emails to recipient users, for example, based on instruction from the client computer PC1 (PC2, PC3) that is the distributor of confidential print.

The clock controller 20 sends to the print controller 10 time information from the clock 23 functioning as a real time clock, which is used for management on the expiration date of confidential print described later.

The print engine controller 21 drives and controls the print mechanism 25 and paper feeder 26. The print engine controller 21 controls the print mechanism 25 according to image data sent from the storage 16, executes printing according to the image data on a recording paper (sheet) supplied from the paper feeder 26, and outputs printout 27.

The procedures of this embodiment with the above configuration will be described hereafter.

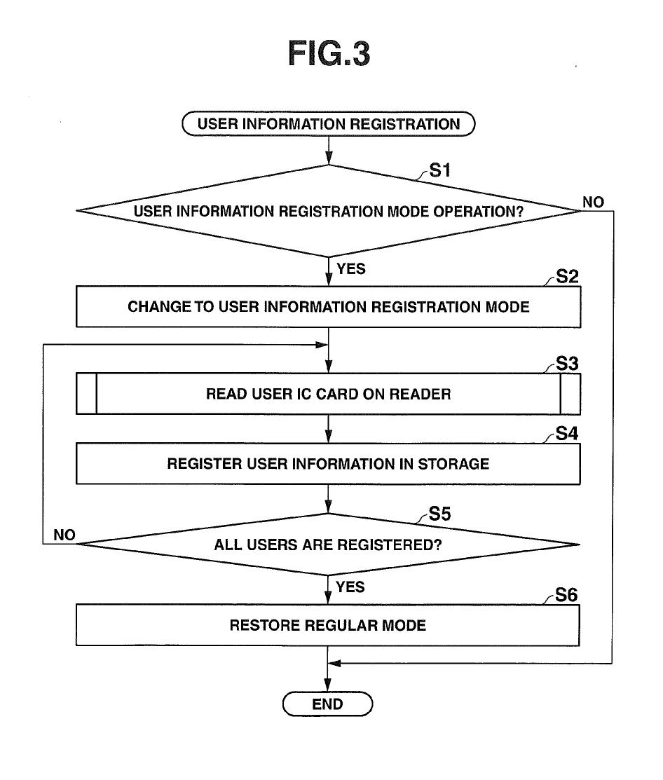

First, the user information registration procedure will be described using the flowchart of FIG. 3. The user information registration procedure is a procedure to register proper users who are allowed to use the system in advance for executing confidential printing at multiple destinations using the print data distribution management system of this embodiment.

First, it is determined whether an operation to set the printing device 1 to the user information registration mode is conducted (Step (S, hereafter) 1). This operation is conducted by, for example, operating a given key of the display operator 22. If the operation is not conducted, the procedure ends (NO at S1). If the operation is conducted (YES at S1), the print controller 10 changes the printing device 1 to the user information registration mode (S2).

Then, the IC card 8 of a user who uses the system is placed over the IC card reader/writer 4 and the user information recorded on the IC card 8 is read (S3). With this processing, the user information read from the IC card 8 is registered in the storage 16 under the control of the print controller 10 (S4).

The above processing is executed for all users who use the system. If the user information of all users is not registered (NO at S5), the above processing is repeated (S3, S4); the IC card 8 is placed to register the user information in the storage 16 in sequence. Then, after the user information of all users is registered in the storage 16 (YES at S5), the regular mode is restored (S6). Then, with the above processing, the information of users (proper users) who use the system is registered in the storage 16 and used in the subsequent processing.

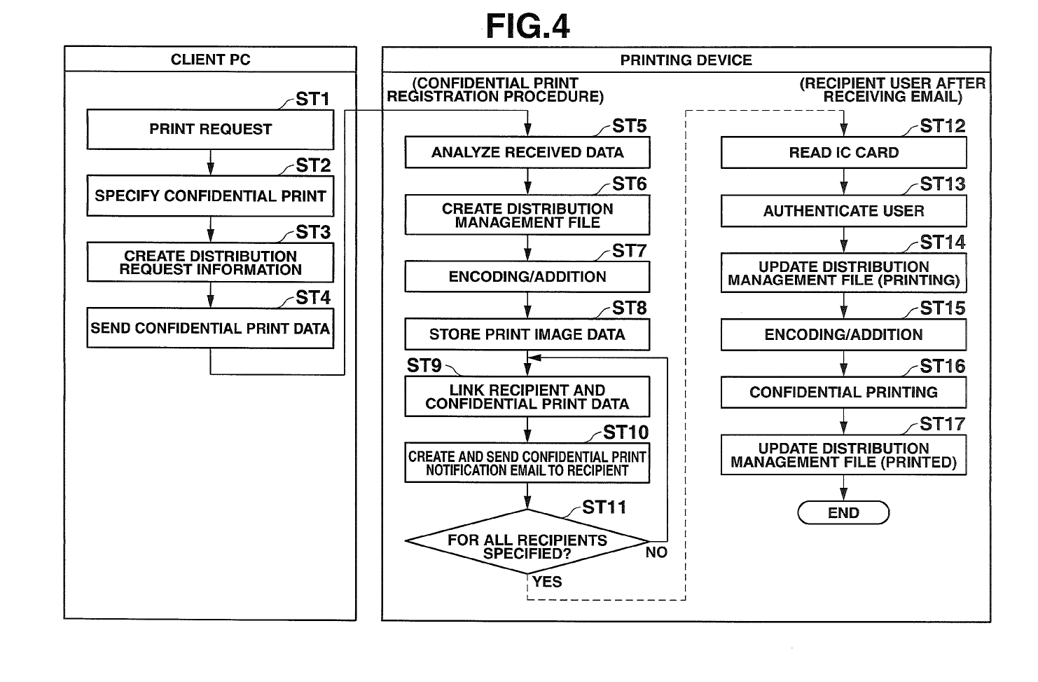

The print data distribution management procedure of this embodiment will be described hereafter using the flowchart of FIG. 4. In the figure, the processing of the client computer PC1 (PC2, PC3) is shown on the left and the processing of the printing device 1 is shown on the right.

First, the distributor (distribution origin) of a distribution document creates print data of the distribution document using, for example, the client computer PC1. In other words, the distributor creates print data using the application programs 6 installed on the client computer PC1 and makes a print request (Step (ST, hereafter) 1). In doing so, confidential print is specified by means of a property of the printer driver 7 (ST2).

As confidential print is specified, the printer driver 7 reads all user information registered in the printing device 1 in advance and displays a recipient selection screen. The user information is registered in the storage 16 as described above. The information is read from the printing device 1 and displayed on the recipient selection screen.

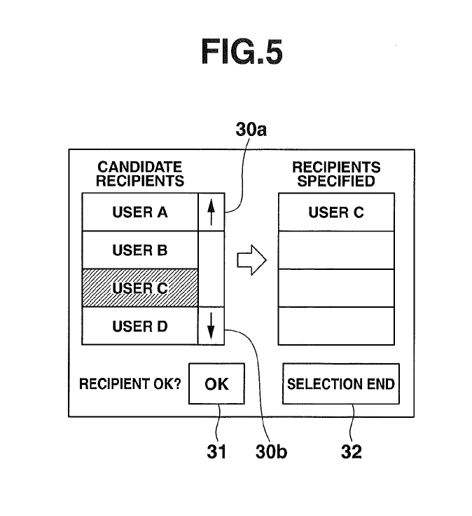

FIG. 5 is an illustration showing an example of the recipient selection screen. The user information read from the storage 16 is displayed under CANDIDATE RECIPIENTS shown in the figure. An upward or downward arrow key or mouse is operated to display the user information in sequence. Then, as OK is specified, for example, the highlighted user among the candidate recipients is selected. In the example of FIG. 5, a user (USER C) is selected. The above selection process is similarly executed and multiple recipient users are displayed under RECIPIENTS SPECIFIED. As SELECTION END is specified, the recipient selection procedure ends.

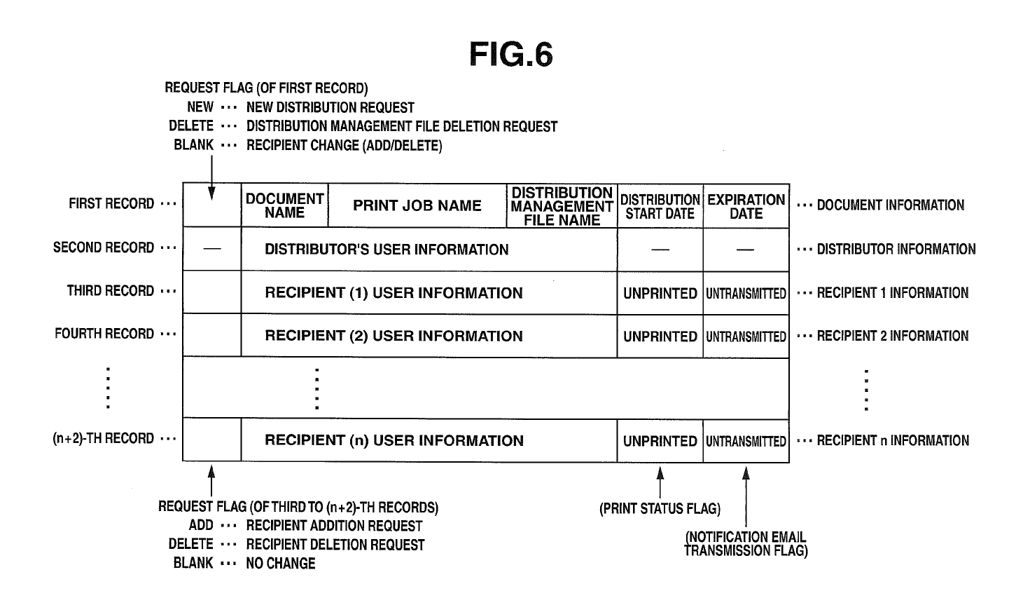

After the recipient users are specified in the above processing, the printer driver 7 creates recipients' user information as distribution request information (ST3). FIG. 6 shows the format structure of the distribution request information.

The first record stores print information to distribute, including the fields of a request flag, document name, print job name, distribution management file name, distribution start date, and expiration date. The request flag is set to “NEW,” “DELETE,” or “BLANK.” For example, the request flag is set to “NEW” when new distribution request information is created, to “DELETE” for making a request for deleting the distribution management file after or during the distribution process, and to “BLANK” for making a request for recipient change to add and/or delete recipients.

The document name field contains the name of a document to be distributed. The print job name field contains a print job name. The distribution management file name field contains the name of a distribution management file. The distribution start date field contains the date on which distribution of the print data starts. The expiration date field contains the distribution expiration date of the print data. The confidential print is available until the distribution expiration date and after this date, the confidential print is no longer available and the distribution management file will be deleted as described later.

The second record contains information on the distributor, including the fields of a request flag, distributor's user information, distribution start date, and expiration date. The distributor's user information field contains user information of the distributor including the user name, user code, user attribute, email address, and IC card number. The request flag, distribution start date, and expiration date fields of the second record are blank. This blank is different from the above “BLANK” and means nothing.

The third and subsequent records, namely the third record to the (n+2)-th record, contain the user information of recipients, including the fields of a request flag, recipient's user information, print status flag (indicated at the bottom right of FIG. 6), and notification email transmission flag (indicated at the bottom right of FIG. 6). The request flag is used for recipient change (when the request flag of the first record is blank, namely indicating recipient change). The request flag field is set to “ADD,” “DELETE,” or “BLANK.” For example, the request flag field is set to “ADD” for making a request for adding a recipient and to “DELETE” for making a request for deleting a recipient; the “BLANK” means no change.

The recipient's user information field contains information of a recipient (RECIPIENTS 1, 2, . . . ) including the user name, user code, user attribute, email address, and IC card number. Here, with this distribution request information, in the case of a new distribution request (the request flag of the first record is NEW), the print status flags of the third and subsequent records are all set to UNPRINTED and the notification email transmission flags thereof are all set to UNTRANSMITTED.

After the distribution request information having the above format is created, the printer driver 7 converts the print data to intermediate data (PDL data) corresponding to the printing device 1 as described above, incorporates the distribution request information in the header part of the print date, and sends the print data (the confidential print data, hereafter) to the printing device 1 (ST4).

On the other hand, the print controller 10 of the printing device 1 receives the confidential print data sent from the client computer PC1 (PC2, PC3) and analyzes the received data (ST5). This analysis is command analysis on the confidential print data to create print image data. In doing so, acknowledging the presence of the distribution request information in the header part of the confidential print data, the print controller 10 recognizes the confidential print data and reads the distribution request information incorporated in the header part.

Then, if the request flag in the read distribution request information contains “NEW,” the distribution status controller 17 creates a distribution management file using the distribution request information (ST6). The distribution management file is named according to the distribution management file name in the distribution request information. At this time, the print status flags of the recipients are set to “UNPRINTED” as they are and the notification email transmission flags thereof are set to “UNTRANSMITTED” as they are.

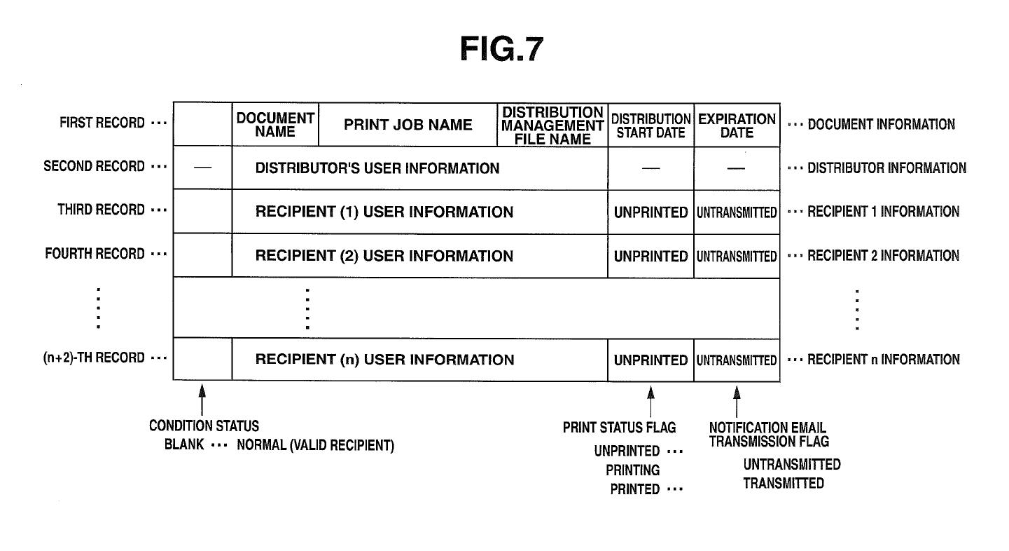

FIG. 7 is an illustration showing the data structure of a distribution management file (distribution management information). The distribution management file is created based on the distribution request information sent from the client computer PC1 (PC2, PC3) as described above and has nearly the same structure as the distribution request information. However, the blank request flag fields of the first and second records mean nothing and the blank in the corresponding fields of the third to (n+2)-th records to the request flags indicates that the condition status is normal and therefore a valid recipient.

After the distribution management file is created in the above processing, the user information addition controller 14 encodes the distributor's user information in the distribution request information, converts the encoded information (character data) to image data, and adds them to the above-mentioned print image data (ST7). For example, when the print image data are printed out, with the addition of the above image data, the distributor information is printed in the top margin of the printout 27 and can be used as a proof of origin.

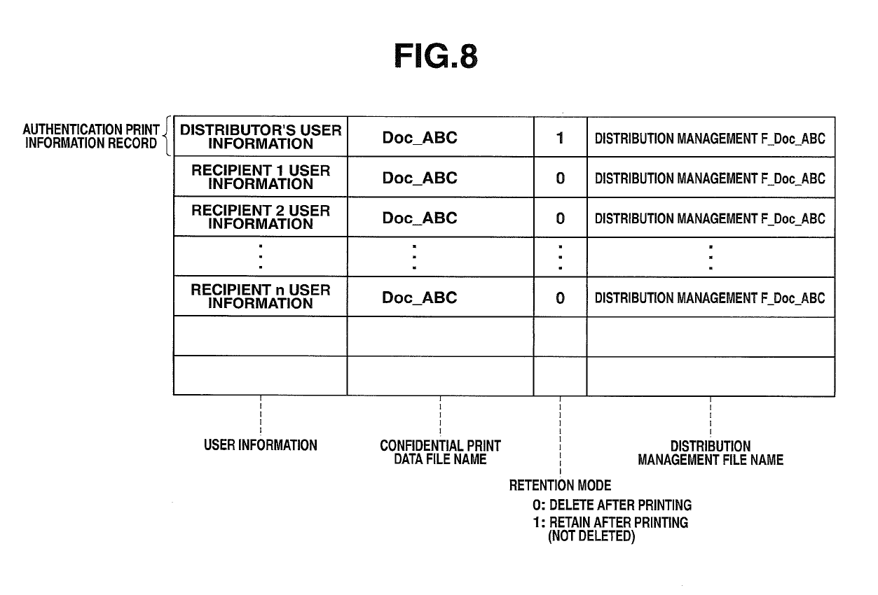

Then, the print controller 10 stores in the storage 16 the print image data to which the encoded distributor's user information is added (ST8). Furthermore, here, the distributor's user information is linked to the confidential print data. The user information is linked to the confidential print data by registering authentication print information records shown in FIG. 8 in an authentication print management table. As shown in the figure, an authentication print information record comprises user information, a confidential print data file name, a retention mode, and a distribution management file name. Here, the confidential print data file name is the name of the confidential print data file stored in the storage 16 in the above processing (ST8). The distribution management file name is the name of the distribution management file created in the above processing (ST6). The retention mode is set to “1,” which indicates retention after the printing.

Then, the recipient's user information is linked to the confidential print data (ST9). The user information is linked to the confidential print data by registering authentication print information records in an authentication print management table in the same manner as the distributor's user information being linked to the confidential print data as described above. However, the retention mode is set to “0,” which indicates deletion after the printing.

Then, the email controller 19 reads the email addresses contained in the recipients' user information in the third and subsequent records of the distribution request information shown in FIG. 6, and creates and sends an email indicating arrival of confidential print (confidential print notification email) to the read email addresses (ST10). The confidential print notification email is sent to the recipient users via the above-mentioned email server 2. The contents of the confidential print notification email are, for example, “You have received confidential print ‘YYYYY’ from Mr. XXXX. Please make the printout by MM/DD/YYYY,” in which XXXX is the user name of the distributor of the print data, YYYYY is the print job name, and MM/DD/YYYY is the expiration date.

The above processing is executed for all recipients specified (NO at ST11, ST9, ST10), and the email of the above contents is sent from the distributor to all recipients specified (YES at ST11). After the email is sent, the distribution status controller 17 sets the notification email transmission flags of the recipients to “TRANSMITTED” so as to updates the distribution management file. With this processing, for example, the corresponding notification email transmission flags of the third and subsequent records of the distribution management file shown in FIG. 7 are updated from “UNTRANSMITTED” to “TRANSMITTED.”

On the other hand, receiving the confidential print notification email, the recipient views the contents of the email and, for example for printing the confidential print data, goes to the printing device 1. Then, the recipient user places the IC card 8 over the IC card reader/writer 4 provided to the printing device 1. With this operation, the IC card reader/writer 4 of the printing device 1 reads the user information from the IC card 8 (ST12) and authenticates the user (ST13). In other words, the user information of all users is registered in the storage 16 of the printing device 1 in advance as described above. This user information is read and determined whether to match the user information read from the IC card 8.

Furthermore, the user information read from the IC card 8 is compared with the user information of the above-described authentication print information records in the authentication print management table in FIG. 8. Then, if any authentication print information record matches, the distribution status controller 17 searches the distribution management file specified by the distribution management file mane for the recipient that matches the user information read from the IC card 8, and sets the corresponding print status flag to “PRINTING” so as to update the distribution management file (ST14).

Then, the user information addition controller 14 encodes the recipient's user information read from the IC card 8, converts the encoded information (character data) to image data, reads confidential print data with the confidential print data file name in the authentication print information record, and adds the image data to the print image data of the read confidential print data (ST15). This processing is the same as the above-described processing of encoding the distributor information and adding it to the print image data and executed, for example, for printing the recipient information in the bottom margin in printing out the print image data.

Then, the print controller 10 sends the print image data of the confidential print data to the print engine 24 via the print engine controller 21 to print them out on a recording medium such as paper (ST16). Here, if the retrieved authentication print information record has the retention mode of “0” (deletion after the printing), namely in the case of a recipient, the linkage between the printed user information and confidential print data is deleted. The linkage is deleted by deleting the corresponding authentication print information record from the authentication print management table of FIG. 8. Here, the confidential print data themselves are not deleted. If the retrieved authentication print information record has the retention mode of “1” (retention after the printing), namely in the case of the distributor, neither the linkage nor the confidential print data are deleted.

This is because in this way, there is no need of sending the confidential print data even if a recipient is added after all recipients have made the printout. The confidential print data are deleted at the same time as the distribution management file is deleted as described later.

After the confidential print data are printed, the distribution status controller 17 searches the distribution management file for the recipient that matches the user information read from the IC card 8, and sets the corresponding print status flag to “PRINTED” so as to update the distribution management file (ST17).

If multiple authentication print information records in the authentication print management table shown in FIG. 8 has the user information that matches the user information read from the IC card 8, the same processing (ST14, ST15, ST16, and ST17) is repeated on each of the authentication print information records.

The distributor user operates the client computer PC 1 (PC2, PC3) to acquire the corresponding distribution management file from the storage 16 of the printing device 1 using a file transfer tool such as FTP (file transfer protocol). The distribution status display 31 of the client computer PC 1 (PC2, PC3) links the recipient's user name to the distribution status based on the acquired distribution management file and displays them on the display 32 of the client computer PC1 (PC2, PC3). With this processing, the latest distribution status, namely whether each recipient has printed and received, can be known.

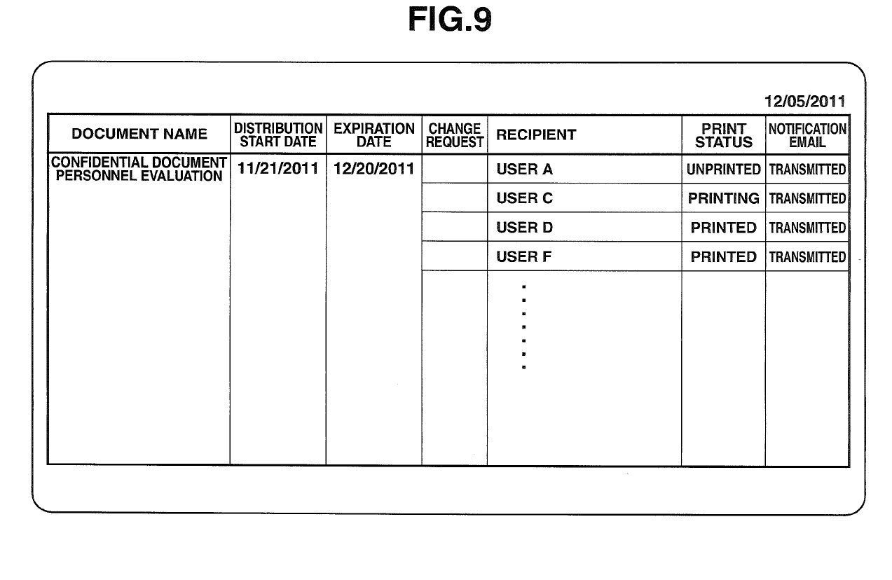

FIG. 9 shows an exemplary display of the distribution status. This display shows the distribution status regarding a print job of which the document name is “CONFIDENTIAL DOCUMENT, PERSONNEL EVALUATION,” the distribution start date is “Nov. 21, 2011,” and the expiration date is “Dec. 20, 2011.” For example, the users D and F have already completed the printing, the user C is printing, and the user A has not printed. Therefore, viewing this display, the distributor user can easily know the reception conditions of the recipients.

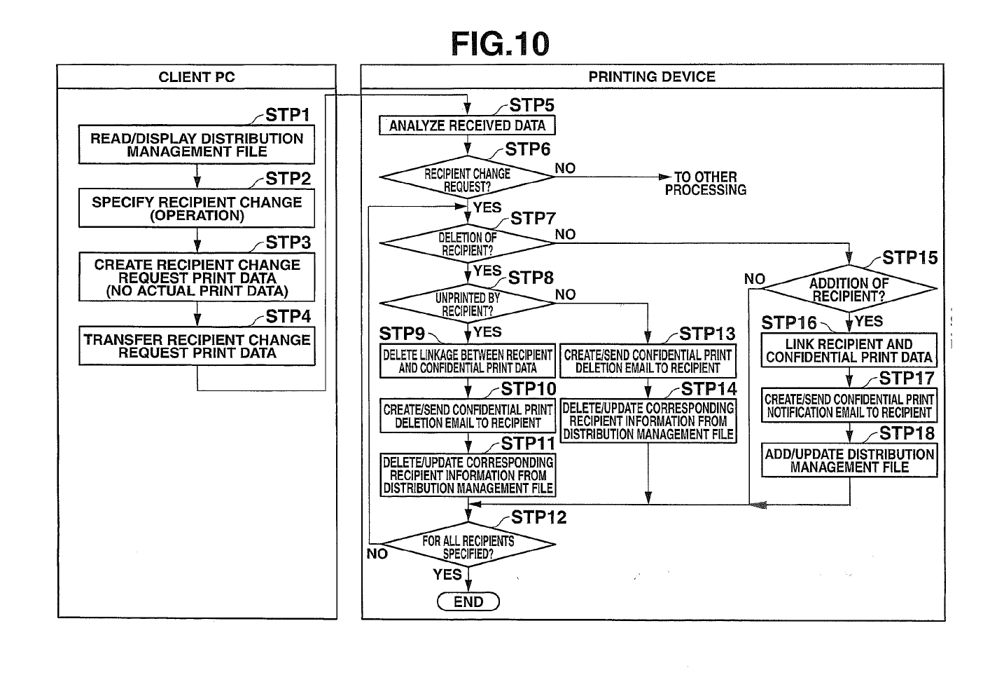

The recipient change procedure to add and/or delete recipients in this embodiment will be described hereafter. This procedure is executed according to the flowchart of FIG. 10 when the distributor user realizes, for example, a missing recipient or a wrong recipient after the print data are distributed.

First, the distributor user reads the print data distribution management file from the printing device 1 using a file transfer tool such as FTP and displays it (Step (STP, hereafter) 1). In doing so, the above-described distribution status display shown in FIG. 9 is presented.

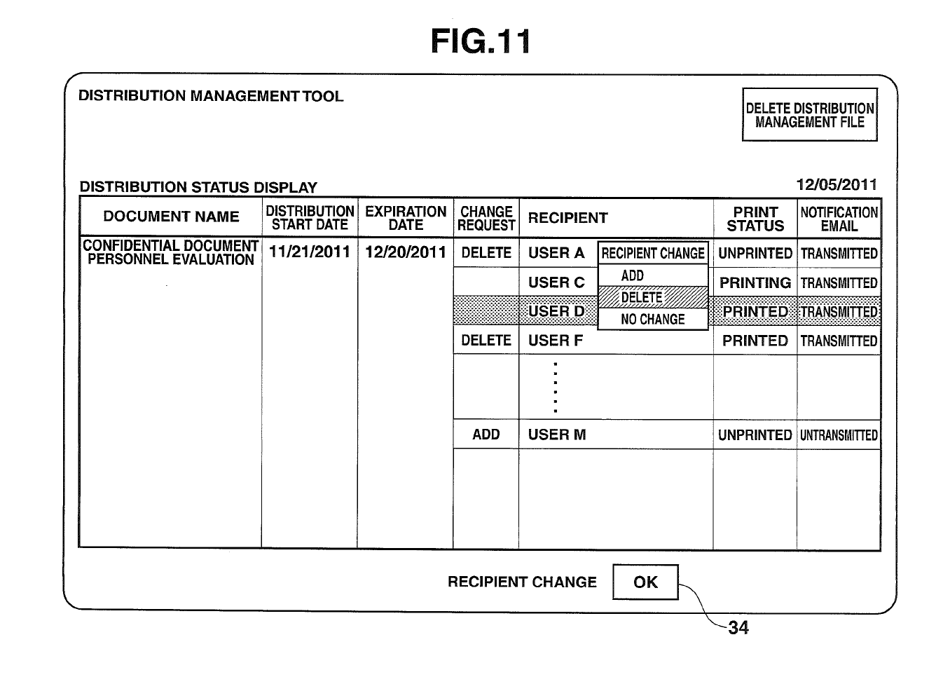

Then, the distributor user specifies recipient change (operation) (STP2). This operation is executed by pointing the recipient to change with a pointer such as a mouse to call for the recipient change function. For example, the distributor user clicks the right button of the mouse to bring up a recipient change pop-up menu and gives a recipient change instruction. For example, FIG. 11 is an illustration for explaining this operation. For example, if distribution is made to a recipient to which the distribution was unnecessary, DELETE on the pop-up menu is pointed so that “DELETE” is highlighted in the recipient change request field, whereby the setting DELETE is made.

On the other hand, if there is a missing recipient, “ADD” is pointed so that a line is inserted, whereby a new recipient is specified in this new line. In this case, all user information registered in the printing device 1 in advance is read, a not-shown recipient selection screen is displayed, and a recipient is specified using the displayed screen. Here, in the case of a wrong recipient (recipient change), the above deletion procedure and addition procedure are executed.

After specifying all recipient changes, OK for recipient change shown in FIG. 11 is specified to create print data for a recipient change request (STP3). The recipient change request has basically the same format as the distribution request information shown in FIG. 6. However, the request flag of the first record (information of print data etc.) of the distribution request information is “BLANK” (recipient change), and the request flags of the recipients' information (the third and subsequent records) contain “DELETE” or “ADD.”

Here, the information of the recipient change request is incorporated in the header part of the print data. This print data contain no actual print data and are transferred to the printing device 1 (STP4).

The printing device 1 receives the above print data via the LAN communication controller 11, and the print controller 10 analyzes the print data (STP5). With this processing, the print controller 10 determines whether it is recipient change request information (STP6). In other words, it is determined whether the header part of the print data contains the distribution request information and the request flag of the first record thereof is “BLANK” (recipient change). Here, if the header part of the print data does not contain the recipient change request information (NO at STP6), the corresponding processing is executed. If it contains the recipient change request information (YES at STP6), first, it is determined whether the recipient change request information is to “DELETE” a recipient.

This is determined based on whether the request flag of the recipient information of the third and subsequent records in the read recipient change request information contains “DELETE.” If it contains “DELETE” (YES at STP7), the distribution management file is searched for the recipient in question and the print status flag is checked. In the case of “UNPRINTED” (YES at STP8), the linkage between the user information of this recipient and the confidential print data is deleted (STP9), and a confidential print deletion email is created and sent to the recipient (STP10). The contents of the confidential print deletion email are, for example, “Confidential print ‘YYYYY’ from Mr. XXXX is canceled,” in which XXXX is the user name of the user information of the print request source and YYYYY is the print job name. Furthermore, the corresponding recipient information is deleted from the distribution management file (STP11).

The above email transmission procedure and recipient deletion procedure are similarly executed on the recipients of which the request flag of the recipient information (the third and subsequent records) in the recipient change request information contains “DELETE” (NO at STP12, STP7 to STP11), whereby the email of the above contents is sent to all recipients for which “DELETE” is specified by the distributor. Then, with the above processing of this embodiment, any wrong recipient user to which the email has sent does not print the corresponding print data or the distributor user himself/herself does not need to send a confidential print deletion email to individual recipient users, eliminating cumbersome operations.

On the other hand, if some recipient has printed the confidential print data (NO at STP8), a confidential print data deletion email is created and sent to this recipient (STP13). The contents of this deletion email are, for example, “Confidential print ‘YYYYY’ is distributed from Mr. XXXX by mistake. The ‘YYYYY’, which you have already printed, is an important document. Please shred and dispose the document properly.” Then, the recipient information is deleted from the distribution management file so as to update the distribution management file (STP14).

Then, with the above processing of this embodiment, the distributor user himself/herself does not need to send a confidential print deletion email to individual recipient users who have already made the printout, and a cumbersome task of retrieving the printout can be omitted.

On the other hand, in regard to the above determination (STP7), if it is not the case of “deleting” a recipient (NO at STP7), it is determined whether it is the case of “adding” a recipient (STP15). This is determined based on whether the request flag of the recipient information of the third and subsequent records of the read recipient change request information contains “ADD.” For example, if “ADD” is found (YES at STP15), the recipient is linked to the confidential print data (STP16). The email controller 19 creates and sends a confidential print notification email to the email address contained in the user information of the recipient (STP17). This email is sent to the recipient user via the above-mentioned email server 2. The contents of this email are the same as the above-described confidential print notification email and, for example, “You have received confidential print ‘YYYYY’ from Mr. XXXX. Please make the printout by MM/DD/YYYY.”

After the above email is sent, the distribution status controller 17 sets the print status flag of the recipient to “UNPRINTED” and the notification email transmission flag to “TRANSMITTED,” and adds/updates the recipient to/in the distribution management file (STP18). The above processing is similarly executed on all added recipients.

Finally, the confidential print data distribution end procedure will be described. The confidential print data distribution end procedure is executed to delete the distribution management file due to the expiration date or for the distributor user to delete the distribution management file.

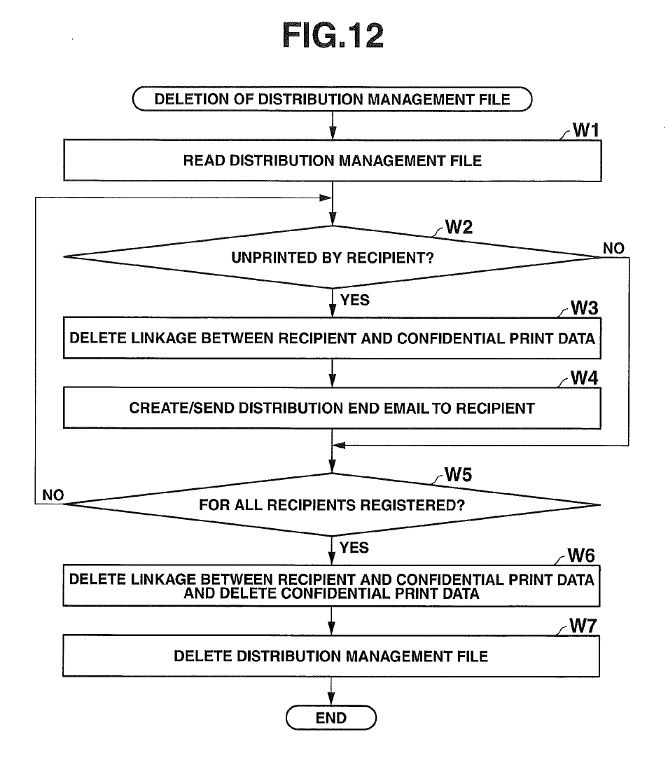

In any case, the distribution management file is deleted according to the flowchart shown in FIG. 12. First, the distribution management file is read (Step (W, hereafter) 1). If the print status flag of each recipient is UNPRINTED (Y at W2), the linkage between the recipient and confidential print data is deleted (W3), and a distribution end email is created and sent to the recipient (W4). The contents of this email are, for example, “The distribution of ‘YYYYY’ from Mr. XXXX has ended,” notifying the recipient of the end.

The above email is sent to all registered recipients (NO at W5, W2 to W4). If the above email is sent to all recipients (YES at W5), the linkage between the distributor and confidential print data is deleted and the confidential print data are deleted (W6). Then, the distribution management file is deleted (W7).

With this embodiment, the status as to whether a recipient user has given a print instruction and received the print data (distribution status) can easily be known.

Furthermore, with this embodiment, the distributor user himself/herself does not need to send a deletion email to an individual recipient user even if confidential print instruction is given to a wrong recipient, or send a notification email to an individual user who is an additional recipient of confidential print, eliminating cumbersome tasks. Furthermore, the distributor is clarified in the printout made by the recipient users, whereby the origin of the print can easily be known.

In the explanation of this embodiment, the distribution request information is set in the header of confidential print data. However, it can be set, for example, in a PDL command. Furthermore, the user information of all proper users is registered in the storage 16 of printing device 1 in advance. However, the user information of all proper users can be consolidated in, for example, the supervising server within the system. In such a case, the client computers PC1 to PC3 and printing device 1 read the user information of all proper users from the above supervising server and use the information.

Furthermore, in the explanation of this embodiment, the user information is read from the IC card 8 for executing confidential printing. For example, it is possible to use an employee number as the user information and enter the employee number through the operation panel of the printing device 1 for executing confidential printing. In such a case, the IC card 8 and IC card reader/writer 4 are unnecessary and the system configuration cost can be reduced.

Furthermore, the printing device 1 sends out a confidential print notification email. The client computers PC1 to PC3 can send out a confidential print notification email. For example, it is possible that when the client computer PC1 (PC2, PC3) of the distributor sends confidential print data including the distribution request information to the printing device 1, the client computer PC1 (PC2, PC3) sends a confidential print notification email to the recipients and the printing device 1 does not. Furthermore, it is possible that the printing device 1 does not send an email upon adding and/or deleting recipients; instead, when the client computer PC1 (PC2, PC3) sends a recipient change request for adding and/or deleting recipients to the printing device 1, the client computer PC1 (PC2, PC3) sends an email to the recipients. With such processing, the email controller 19 of the printing device 1 can be omitted.

Several embodiments of the present invention are described. The present invention is included in the invention set forth in the scope of claims and the scope equivalent thereto.

Having described and illustrated the principles of this application by reference to one (or more) preferred embodiment(s), it should be apparent that the preferred embodiments may be modified in arrangement and detail without departing from the principles disclosed herein and that it is intended that the application be construed as including all such modifications and variations insofar as they come within the spirit and scope of the subject matter disclosed herein.

What is claimed is:

1. A print data distribution management system, comprising:
a distributor terminal used by a user who is the distributor of print data to be distributed;
a recipient terminals used by a distribution receiver of the print data to be distributed; and
a printing device connected to the distributor terminal and the recipient terminal via a network and printing the print data distributed,
wherein the distributor terminal comprises a transmitter including information specifying the distribution receiver in the print data and sending the print data to the printing device, and
the printing device comprises:
a print controller analyzing the print data sent from the transmitter of the distributor terminal and creating print image data;
a print outputter printing out the print image data on a recording medium based on print instruction from the distribution receiver; and
a distribution status manager managing the distribution status of the print image data for the distribution receiver.

2. The print data distribution management system according to claim 1, wherein:
the distribution status manager creates distribution management information including information specifying the distribution receiver and distribution status information linked to the information specifying the distribution receiver and presenting the distribution status of print image data to be distributed to the distribution receiver, and
the distributor terminal comprises:
a display; and
a distribution status display displaying on the display the name of the distribution receiver and the print image data distributed to the distribution receiver based on the distribution management information acquired from a storage of the printing device via the network.

3. The print data distribution management system according to claim 1, wherein:
the distribution status manager
creates distribution management information including information specifying the distribution receiver and distribution status information linked to the information specifying the distribution receiver and presenting the distribution status of print image data to be distributed to the distribution receiver,
registers, as distributor authentication print management information, information linking information specifying the distributor, the file name of the print data, data indicating that the print data are not deleted after the print data are printed, and the distribution management file name to each other, and
registers, as distribution receiver authentication print management information, information linking information specifying the distribution receiver, the file name of the print data, data indicating that the print data are deleted after the print data are printed, and the distribution management file name to each other.

4. The print data distribution management system according to claim 3, wherein:
when the print outputter prints out the print image data based on print instruction from the distribution receiver, the distribution status manager retains the print image data and deletes the distribution receiver authentication print management information of the distribution receiver who gave the print instruction.

5. The print data distribution management system according to claim 4,
when the print outputter prints out the print image data based on print instruction from the distribution receiver, the distribution status manager retains the distributor authentication print management information of the distributor user.

6. The print data distribution management system according to claim 1, wherein:
the printing device comprises a first email transmitter reading information specifying the distribution receiver contained in the print data, and sending a print notification email giving notice of printing the print image data to the recipient terminal of the distribution receiver specified by the information.

7. The print data distribution management system according to claim 1,
the distributor terminal comprises a first email transmitter sending a print notification email giving notice of printing the print image data to the recipient terminal of the distribution receiver specified by the information specifying the distribution receiver.

8. The print data distribution management system according to claim 1,
the distribution status manager creates distribution management information including information specifying the distribution receiver and distribution status information linked to the information specifying the distribution receiver and presenting the distribution status of print image data to be distributed to the distribution receiver,
the distributor terminal comprises an instructor reading the distribution status information created by the distribution status manager and instructing the printing device to delete the distribution receiver linked to the distribution status information, and
the printing device comprises a second email transmitter that, upon receiving an instruction to delete a distribution receiver from the distributor terminal and with the distribution status information linked to the distribution receiver in the distribution status information indicating that the distribution is done, sends a deletion request email making a request for deleting the print image data to the recipient terminal of the distribution receiver on whom the instruction to delete is received.

9. The print data distribution management system according to claim 1,
the distribution status manager
creates distribution management information including information specifying the distribution receiver and distribution status information linked to the information specifying the distribution receiver and presenting the distribution status of print image data to be distributed to the distribution receiver, and
registers, as distribution receiver authentication print management information, information linking information specifying the distribution receiver, the file name of the print data, data indicating that the print data are deleted after the print data are printed, and the distribution management file name to each other,
the distributor terminal comprises an instructor reading the distribution status information created by the distribution status manager and instructing the printing device to delete the distribution receiver linked to the distribution status information, and
the printing device comprises a second email transmitter that, upon receiving an instruction to delete a distribution receiver from the distributor terminal, deletes the distribution receiver authentication print management information of the distribution receiver and sends a deletion notification email giving notice of deleting the print image data to the recipient terminal of the distribution receiver on whom the instruction to delete is received.

10. The print data distribution management system according to claim 9, wherein:
the instructor instructs the printing device to add the distribution receiver,
upon receiving an instruction to add a distribution receiver from the distributor terminal, the distribution status manager registers information linking information specifying the distribution receiver on whom the instruction to add is received, the file name of the print data, data indicating that the print data are deleted after the print data are printed, and the distribution management file name to each other as additional distribution receiver authentication print management information, and
the second email transmitter sends a print notification email giving notice of printing the print image data to the recipient terminal of the distribution receiver on whom the instruction to add is received.

11. The print data distribution management system according to claim 1, wherein:
the distributor terminal comprises a second email transmitter sending a deletion request email making a request for deleting the print image data to the recipient terminal of the distribution receiver on whom the instruction to delete is received.

12. The print data distribution management system according to claim 1, wherein:
information of users who are authorized to use the distributor and recipient terminals is registered in the printing device in advance, and authentication is executed to confirm that the distribution receiver is an authorized user and included in the user information from the distributor terminal before printing the print image data based on printing instruction from the distribution receiver.

13. The print data distribution management system according to claim 1, wherein:
the printing device comprises a third email transmitter sending a deletion notification email giving notice of deleting the print image data to the recipient terminal of the distribution receiver of the print image data when the print image data are deleted.

14. A print data distribution management method for a print data distribution management system, wherein:
the print data distribution management system comprises a distributor terminal used by a user who is the distributor of print data to be distributed; a recipient terminal used by a distribution receiver of the print data to be distributed; and a printing device connected to the distributor terminal and the recipient terminal via a network and printing the print data distributed,
the distributor terminal executes a transmission procedure to include information specifying the distribution receiver in the print data and send the print data to the printing device, and
the printing device executes:
a print control procedure to analyze the print data sent from the transmitter of the distributor terminal and create print image data;
a printing procedure to print out the print image data on a recording medium based on print instruction from the distribution receiver; and
a distribution status management procedure to manage the distribution status of the print image data for the distribution receiver.

15. A printing device connected to a distributor terminal which is used by a user who is the distributor of print data to be distributed and a recipient terminal which is used by a distribution receiver of the print data to be distributed via a network and printing the print data distributed, comprising:
a print controller analyzing the print data sent from a transmitter of the distributor terminal and creating print image data, the transmitter of the distributor terminal including information specifying the distribution receiver in the print data and sending the print data to the printing device;
a print outputter printing out the print image data on a recording medium based on print instruction from the distribution receiver; and
a distribution status manager managing the distribution status of the print image data for the distribution receiver.
